(19) United States
(12) Patent Application Publication
(10) Pub. No.: US 2026/0307401 A1
(43) Pub. Date: Oct. 8, 2026

(54) HOLDER, TAPE CASSETTE AND IMAGE FORMING APPARATUS

(71) Applicant: BROTHER KOGYO KABUSHIKI KAISHA, Nagoya (JP)

(72) Inventors: Sho ASAI, Nagoya (JP); Yushi KATO, Nagoya (JP); Yohsuke HATA, Nagoya (JP); Narumi TODA, Nagoya (JP)

(21) Appl. No.: 19/463,002

(22) Filed: Jan. 28, 2026

(30) Foreign Application Priority Data
Jan. 30, 2025 (JP) 2025-014228

(51) Int. Cl. B41J 11/00; B41J 3/407; B41J 15/04

(52) U.S. Cl. CPC B41J 11/0075; B41J 3/4075; B41J 11/009; B41J 15/042; B41J 15/046

(57) ABSTRACT

The holder includes a first side plate, a second side plate, a shaft, and a memory. The shaft extends in a first direction. The first side plate is located at one end of the shaft in the first direction. The second side plate is located at the another end of the shaft. The first side plate includes a first surface facing the second side plate in the first direction, and a second surface located at the opposite side of the first surface. The memory includes an electrical contact surface. The electrical contact surface is located at the second surface and faces in a direction from the second side plate toward the first side plate.

### REFERENCE TO RELATED APPLICATIONS

This application claims priority from Japanese Patent Application No. 2025-014228 filed on Jan. 30, 2025. The entire content of the priority application is incorporated herein by reference.

### BACKGROUND ART

Conventionally, tape printing devices that include a holder for mounting a tape roll and a main body housing to which the holder can be attached and detached are known. The holder includes an identification part having a shape that allows identification of the type of tape roll. The identification part has a number of holes corresponding to the type of tape roll. The main body housing includes a switch for reading the type of tape roll, and the switch is configured to contact the identification part.

### SUMMARY

However, in recent years, there has been a demand for an increased variety of tape rolls, and the hole patterns of the identification part cannot accommodate all types. Furthermore, it is desirable to be able to read information other than the type of tape roll, such as the remaining amount of tape roll, from the holder.

Accordingly, the present disclosure aims to enable a large amount of information to be read from the holder.

The holder of the present disclosure comprises a shaft, a first side plate, a second side plate, and a memory. The shaft extends in a first direction. The shaft is configured to allow a tape roll to be mounted. The first side plate is located at one end of the shaft in the first direction. The second side plate is located at another end of the shaft. The second side plate is located away from the first side plate in the first direction. The memory includes an electrical contact surface. The first side plate includes a first surface and a second surface. The first surface faces the second side plate in the first direction. The second surface is located at the opposite side of the first surface in the first direction. The electrical contact surface is located at the second surface. The electrical contact surface faces in the direction from the second side plate toward the first side plate.

By configuring the holder to include a memory, a large amount of information can be read from the memory of the holder.

According to another aspect, the first side plate may extend in a second direction crossing the first direction. In this case, the first side plate includes one end and another end in the second direction. The electrical contact surface may be located closer to the another end of the first side plate than to the one end of the first side plate in the second direction.

According to still another aspect, the first side plate may extend in a second direction crossing the first direction. In this case, the first side plate includes one end and another end in the second direction. A distance between the electrical contact surface and the another end of the first side plate in the second direction may be shorter than a distance between the electrical contact surface and the one end of the first side plate in the second direction.

According to still another aspect, the first side plate may extend in a second direction crossing the first direction. In this case, the first side plate includes one end and another end in the second direction. The second side plate may extend in the second direction. In this case, the second side plate includes one end and another end in the second direction. The one end of the shaft in the first direction may be located at the another end of the first side plate in the second direction. The another end of the shaft in the first direction may be located at the another end of the second side plate in the second direction.

According to still another aspect, the memory may store at least one of a remaining amount of the tape roll, a number of times the holder has been reused, and a type of the tape roll.

According to still another aspect, the shaft may extend from the second side plate to the first side plate in the first direction.

According to still another aspect, in a state where the tape roll is mounted to the shaft, the tape roll may be located between the first side plate and the second side plate.

According to still another aspect, the shaft may connect the first side plate and the second side plate.

According to still another aspect, in a state where the tape roll is mounted to the shaft, the electrical contact surface may face away from the tape roll in the first direction.

According to still another aspect, the first side plate may include a guide protrusion protruding in the first direction, and the electrical contact surface may be located at the outer surface of the guide protrusion.

According to still another aspect, the guide protrusion may extend in a second direction crossing the first direction. In this case, the guide protrusion includes one end and another end in the second direction. The electrical contact surface may be located closer to the another end of the guide protrusion than to the one end of the guide protrusion in the second direction.

According to still another aspect, the guide protrusion may extend in a second direction crossing the first direction. In this case, the guide protrusion includes one end and another end in the second direction. A distance between the electrical contact surface and the another end of the guide protrusion in the second direction may be shorter than a distance between the electrical contact surface and the one end of the guide protrusion in the second direction.

According to still another aspect, the holder may include a bottom plate that extends in the first direction from one end of the first side plate in a second direction which crosses the first direction. The electrical contact surface may be located between the shaft and the bottom plate in the second direction.

According to still another aspect, at least a part of the electrical contact surface may be aligned with the shaft in the first direction.

According to still another aspect, all of the electrical contact surface may be aligned with the shaft in the first direction.

According to still another aspect, the first side plate may include one end and another end located away from the one end in the second direction. The holder may include a bottom plate extending in the first direction from the one end of the first side plate. A distance between the electrical contact surface and the bottom plate in the second direction may be longer than a distance between the electrical contact surface and the another end of the first side plate.

According to still another aspect, the holder further may comprises a bottom plate extending in the first direction from one end of the first side plate, and an identification portion located at the bottom plate.

According to still another aspect, the identification portion may have a shape that enables identification of the type of tape roll.

The tape cassette of the present disclosure comprises a holder and a tape roll. The holder includes a shaft, a first side plate, a second side plate, and a memory. The shaft extends in a first direction. The first side plate is located at one end of the shaft in the first direction. The second side plate is located at another end of the shaft. The second side plate is located away from the first side plate in the first direction. The memory includes an electrical contact surface. The tape roll is rotatable about the shaft. The first side plate includes a first surface and a second surface. The first surface faces the second side plate in the first direction. The second surface is located at the opposite side of the first surface in the first direction. The electrical contact surface is located at the second surface. The electrical contact surface faces in the direction from the second side plate toward the first side plate.

By configuring the holder to include a memory, a large amount of information can be read from the memory of the holder.

The image forming apparatus of the present disclosure comprises a tape cassette and a housing to which the tape cassette is detachably mountable. The tape cassette includes a holder and a tape roll. The holder includes a shaft, a first side plate, a second side plate, and a memory. The shaft extends in a first direction. The first side plate is located at one end of the shaft in the first direction. The second side plate is located at another end of the shaft. The second side plate is located away from the first side plate in the first direction. The memory includes an electrical contact surface. The tape roll is rotatable about the shaft. The first side plate includes a first surface and a second surface. The first surface faces the second side plate in the first direction. The second surface is located at the opposite side of the first surface in the first direction. The electrical contact surface is located at the second surface. The electrical contact surface faces in the direction from the second side plate toward the first side plate. The housing includes an electrical contact. The electrical contact is configured to contact the electrical contact surface.

By configuring the holder to include a memory, a large amount of information can be read from the memory of the holder.

According to another aspect, the first side plate may include a guide protrusion protruding in the first direction, and the housing may have a guide groove into which the guide protrusion is inserted. In a state where the guide protrusion is inserted into the guide groove, the electrical contact surface may be in contact with the electrical contact.

According to still another aspect, the housing may include a cover and a hook. The cover is rotatable about a cover shaft extending in the first direction. The hook contacts the first side plate when the tape cassette is mounted in the housing.

According to still another aspect, the holder may include a bottom plate extending in the first direction from one end of the first side plate in a second direction, and an identification portion located at the bottom plate. The housing may include a switch that can contact the identification portion when the tape cassette is mounted in the housing.

### BRIEF DESCRIPTION OF DRAWINGS

FIG. 1 is a perspective view showing an image forming apparatus according to the first embodiment.

FIG. 2 is a perspective view showing a tape cassette.

FIG. 3 is a perspective view showing the tape cassette in an exploded state.

FIG. 4A is a perspective view showing the relationship between the shaft hole and the hook.

FIG. 4B is a cross-sectional view showing the relationship between the shaft hole and the hook.

FIG. 5 is a cross-sectional view showing the relationship between the housing and the holder.

FIG. 6A is an illustrative view explaining the method for reusing the holder, showing the step of inserting a jig into the shaft.

FIG. 6B is an illustrative view explaining the method for reusing the holder, showing the step of bringing the jig into contact with the hook.

FIG. 6C is an illustrative view explaining the method for reusing the holder, showing the step of detaching the first side plate from the shaft.

FIG. 7A is an illustrative view explaining the method for reusing the holder, showing the step of mounting a new tape roll onto the shaft.

FIG. 7B is an illustrative view explaining the method for reusing the holder, showing the step of mounting the first side plate onto the shaft.

FIG. 8A and 8B are perspective views showing a tape cassette according to the second embodiment.

FIG. 9 is a perspective view showing the holder of the second embodiment in an exploded state.

FIG. 10 is a perspective view showing the relationship between the groove of the shaft and the hook.

FIG. 11 is a view showing the first side plate as seen from the another side in the first direction.

FIG. 12 is a view corresponding to section XII-XII of FIG. 11, showing the state where the first side plate is assembled to the shaft.

FIG. 13 is a view corresponding to section XIII-XIII of FIG. 11, showing the state where the first side plate is assembled to the shaft.

FIG. 14A and 14B are illustrative views explaining the method for reusing the holder, showing the step of passing the jig through the first exposure hole.

FIG. 14C and 14D are illustrative views explaining the method for reusing the holder, showing the step of moving the hook from the first position to the second position with the jig.

FIG. 15 is a cross-sectional view showing an image forming apparatus according to the third embodiment.

FIG. 16A and 16B are perspective views showing a holder according to the fourth embodiment.

FIG. 17A and 17B are perspective views showing a holder according to the fifth embodiment.

### DESCRIPTION

### First Embodiment

The first embodiment of the present disclosure will be described in detail below with reference to the accompanying drawings as appropriate. In the following description, the directions are explained using a first direction, a second direction, and a third direction. In this embodiment, the first direction is the direction in which the first side plate 30 and the second side plate 40, described later, face each other. In other words, the first direction is the direction in which the shaft 50, described below, extends. The second direction is the direction in which the hole 51A and the slit 52, described later, face each other. The third direction is the direction in which the holes 51B and 51C, described later, face each other. In this embodiment, the second direction is orthogonal to the first direction. The third direction is orthogonal to both the first direction and the second direction. In the drawings, arrows indicating each direction point to one side of each direction. The end on one side is referred to as the “one end,” and the end on the other side is referred to as the “another end.”

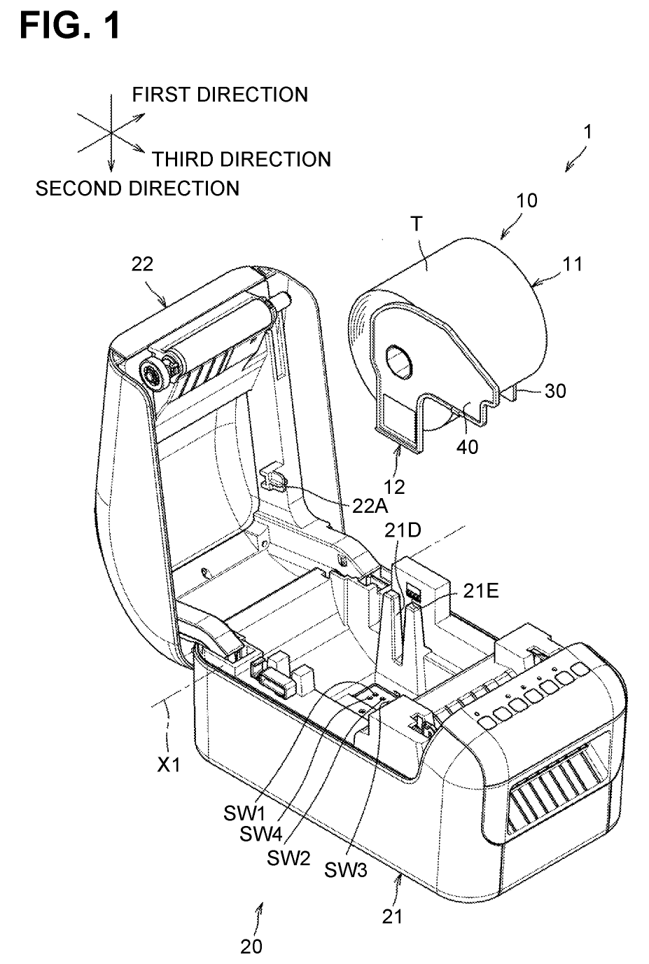

As shown in FIG. 1, the image forming apparatus 1 is a thermal printer of the thermal type. The image forming apparatus 1 thermally prints images such as characters, numbers, symbols, and figures on a tape T. The tape T is a long, strip-shaped thermal paper.

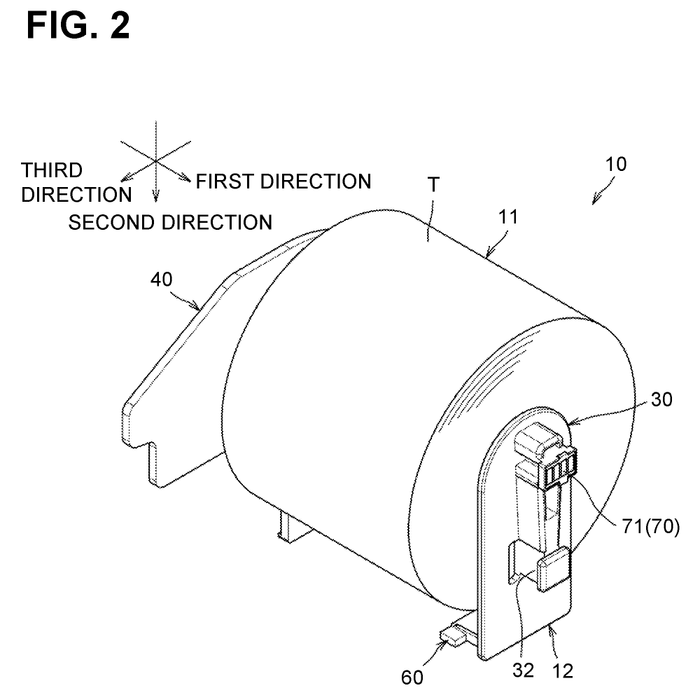

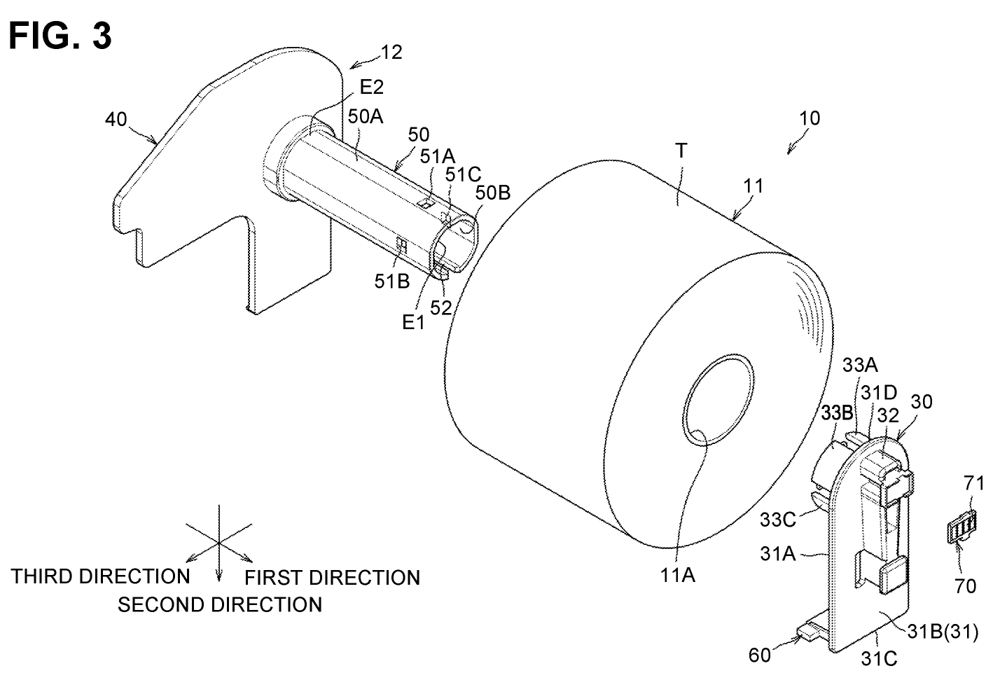

The image forming apparatus 1 includes a tape cassette 10 and a housing 20 to which the tape cassette 10 can be detachably attached. As shown in FIGS. 2 and 3, the tape cassette 10 includes a tape roll 11 and a holder 12.

The tape roll 11 includes a roll 11A and a tape T. The roll 11A is cylindrical. The tape T is wound around the roll 11A.

The holder 12 rotatably supports the tape roll 11. The holder 12 is made, for example, of resin. The holder 12 includes a first side plate 30, a second side plate 40, a shaft 50, a bottom plate 60, and a memory 70. When the tape roll 11 is mounted to the shaft 50, the tape roll 11 is located between the first side plate 30 and the second side plate 40.

The first side plate 30 is attachable and detachable with respect to the shaft 50. The second side plate 40 and the shaft 50 are integrally molded. Note that the second side plate 40 and the shaft 50 may be formed separately. In the state where the first side plate 30 is mounted to the shaft 50, the first side plate 30 is located at one end E1 of the shaft 50 in the first direction. The first side plate 30 extends in the second direction.

The second side plate 40 faces the first side plate 30 in the first direction. The second side plate 40 is spaced apart from the first side plate 30 in the first direction. The second side plate 40 is located at the another end E2 of the shaft 50 in the first direction. The second side plate 40 extends in the second direction.

The shaft 50 is a tube extending in the first direction. In this embodiment, the shaft 50 is a polygonal tube, but it may also be a cylindrical tube. The shaft 50 is configured to mount the tape roll 11. In the state where the tape roll 11 is mounted to the shaft 50, the shaft 50 is inserted into the roll 11A of the tape roll 11. The shaft 50 connects the first side plate 30 and the second side plate 40. The shaft 50 extends from the second side plate 40 to the first side plate 30 in the first direction.

The shaft 50 has three holes 51A, 51B, and 51C, and a slit 52. The three holes 51A, 51B, and 51C are through holes that penetrate from the outer peripheral surface 50A to the inner peripheral surface 50B of the shaft 50.

The hole 51A is located at the inner peripheral surface 50B and also at the outer peripheral surface 50A of the shaft 50. The hole 51B is located at the inner peripheral surface 50B and also at the outer peripheral surface 50A of the shaft 50. In addition, in the circumferential direction of the shaft 50, the hole 51B is spaced apart from the hole 51A. The hole 51C is located at the inner peripheral surface 50B and also at the outer peripheral surface 50A of the shaft 50. In addition, in the circumferential direction of the shaft 50, the hole 51C is spaced apart from the holes 51A and 51B.

In other words, the three holes 51A, 51B, and 51C open to the inside and outside of the shaft 50. Moreover, each of the three holes 51A, 51B, and 51C is spaced apart from each other in the circumferential direction of the shaft 50.

The hole 51A faces the slit 52 in the second direction. The hole 51B faces the hole 51C in the third direction.

The slit 52 is located at one end of the shaft 50 in the first direction. The slit 52 opens toward one side in the first direction. The slit 52 penetrates from the outer peripheral surface 50A to the inner peripheral surface 50B of the shaft 50.

The first side plate 30 includes a plate-shaped portion 31, a guide protrusion 32, and three walls 33A, 33B, and 33C. The plate-shaped portion 31 includes a first surface 31A and a second surface 31B. The first surface 31A and the second surface 31B are orthogonal to the first direction. The first surface 31A faces the second side plate 40. In other words, the first surface 31A faces the second side plate 40 in the first direction. The second surface 31B is located at the opposite side of the first surface 31A in the first direction. The second surface 31B faces the direction opposite to the first surface 31A. The plate-shaped portion 31 extends in the second direction. The plate-shaped portion 31 includes one end portion 31C in the second direction and another end portion 31D in the second direction. The another end portion 31D is located at a distance from the one end portion 31C in the second direction. One end portion E1 of the shaft 50 in the first direction is located at the another end portion 31D of the first side plate 30 in the second direction. Note that the another end portion E2 of the shaft 50 in the first direction may be located at the another end portion of the second side plate 40 in the second direction.

The guide protrusion 32 protrudes from the second surface 31B in the first direction. The three walls 33A, 33B, and 33C protrude from the first surface 31A in the first direction. The three walls 33A, 33B, and 33C have an arc shape. The three walls 33A, 33B, and 33C are arranged in a circular manner in the circumferential direction of the shaft 50. When the first side plate 30 is mounted to the shaft 50, the three walls 33A, 33B, and 33C surround the shaft 50. When the first side plate 30 is mounted to the shaft 50, the three walls 33A, 33B, and 33C contact the outer peripheral surface 50A of the shaft 50. When the first side plate 30 is mounted to the shaft 50, the three walls 33A, 33B, and 33C hold the shaft 50. The wall 33B is located at a distance from the wall 33A in the circumferential direction of the shaft 50. The wall 33C is located at a distance from the wall 33A and the wall 33B in the circumferential direction of the shaft 50.

The bottom plate 60 extends in the first direction from the one end portion 31C of the first side plate 30 in the second direction. Specifically, the bottom plate 60 extends from the one end portion 31C of the plate-shaped portion 31 in the second direction toward the second side plate 40.

The memory 70 includes an electrical contact surface 71. The electrical contact surface 71 is located at the outer surface of the first side plate 30. Specifically, the electrical contact surface 71 is located at the outer surface of the guide protrusion 32. In other words, the memory 70 is located at the outer surface of the first side plate 30. Specifically, the memory 70 is located at the outer surface of the guide protrusion 32.

The electrical contact surface 71 is located at the outer surface of the second surface 31B. Specifically, the electrical contact surface 71 is located at the outer surface of the guide protrusion 32. The electrical contact surface 71 faces in the direction opposite to the direction in which the first side plate 30 faces the second side plate 40. In other words, when the tape roll 11 is mounted to the shaft 50, the electrical contact surface 71 faces away from the tape roll 11 in the first direction. Furthermore, the electrical contact surface 71 faces in the direction from the second side plate 40 toward the first side plate 30.

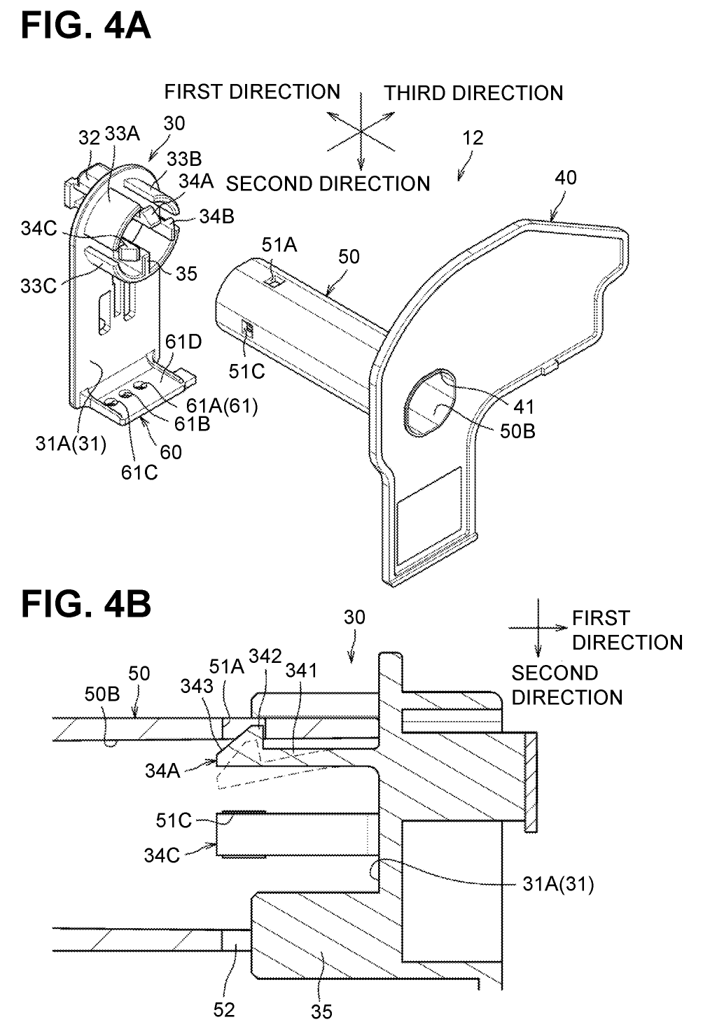

As shown in FIG. 4A, the first side plate 30 further includes three hooks 34A, 34B, and 34C, and a protrusion 35. The three hooks 34A, 34B, 34C and the protrusion 35 protrude from the first surface 31A of the plate-shaped portion 31. The three hooks 34A, 34B, 34C and the protrusion 35 are located at the inside of the three walls 33A, 33B, and 33C.

The hook 34B is located at a distance from the hook 34A in the circumferential direction of the shaft 50. The hook 34C is located at a distance from the hook 34A and the hook 34B in the circumferential direction of the shaft 50.

The hooks 34A, 34B, and 34C have the same shape, respectively. Therefore, hereinafter, only the hook 34A will be described as a representative. Also, since the relationship between the hook 34A and the hole 51A, the hook 34B and the hole 51B, and the hook 34C and the hole 51C are the same, only the relationship between the hook 34A and the hole 51A will be described as a representative.

As shown in FIG. 4B, when the first side plate 30 is mounted to the shaft 50, the hook 34A is located at the inside of the shaft 50. In other words, when the first side plate 30 is mounted to the shaft 50, the hook 34A faces the inner peripheral surface 50B of the shaft 50.

When the first side plate 30 is mounted to the shaft 50, the protrusion 35 enters the slit 52 of the shaft 50. As a result, the rotation of the first side plate 30 about the shaft 50 is restricted by the protrusion 35.

When the first side plate 30 is mounted to the shaft 50, the hook 34A is movable between a first position indicated by a solid line and a second position indicated by a two-dot chain line. Specifically, the hook 34A is elastically deformable between the first position and the second position.

When the hook 34A is located at the first position, the hook 34A fits into the hole 51A. When the hook 34A is located at the second position, the hook 34A is separated from the hole 51A.

The hook 34A includes an arm 341 and a claw 342. The arm 341 is elastically deformable. The arm 341 extends from the first surface 31A of the plate-shaped portion 31 toward the second side plate 40 in the first direction.

The claw 342 is located at the tip of the arm 341. The claw 342 protrudes from the arm 341 toward the hole 51A. When the hook 34A is located at the first position, the claw 342 enters the hole 51A. When the hook 34A is located at the second position, the claw 342 disengages from the hole 51A.

The claw 342 includes an inclined surface 343 that is inclined with respect to the first direction. The inclined surface 343 inclines so as to approach the hole 51A as it gets closer to the first side plate 30.

When the hook 34A is located at the first position, a part of the inclined surface 343 enters the hole 51A. When the hook 34A is located at the first position, another part of the inclined surface 343 is located outside the hole 51A.

As shown in FIG. 4A, the second side plate 40 has an opening 41 that exposes the inner peripheral surface 50B of the shaft 50. In the first direction, the opening 41 overlaps with the three hooks 34A, 34B, and 34C. In other words, when viewed from the first direction, the opening 41 overlaps with the three hooks 34A, 34B, and 34C.

The holder 12 further includes an identification section 61 located at the bottom plate 60. The identification section 61 has a shape that allows identification of the type of tape roll 11. Specifically, the identification section 61 has three holes 61A, 61B, and 61C arranged in a pattern according to the type of tape roll 11, and a portion 61D of the bottom plate 60 that does not have the holes 61A, 61B, and 61C.

As shown in FIG. 1, the housing 20 includes a housing body 21 and a cover 22. The housing body 21 includes four switches SW1, SW2, SW3, and SW4, a guide groove 21D, and an electrical contact 21E.

The guide groove 21D is a groove into which the guide protrusion 32 of the holder 12 enters. By the guide protrusion 32 of the holder 12 entering the guide groove 21D, the tape cassette 10 is attached to the housing body 21. The guide groove 21D extends in the second direction. The guide groove 21D opens toward the other side in the second direction.

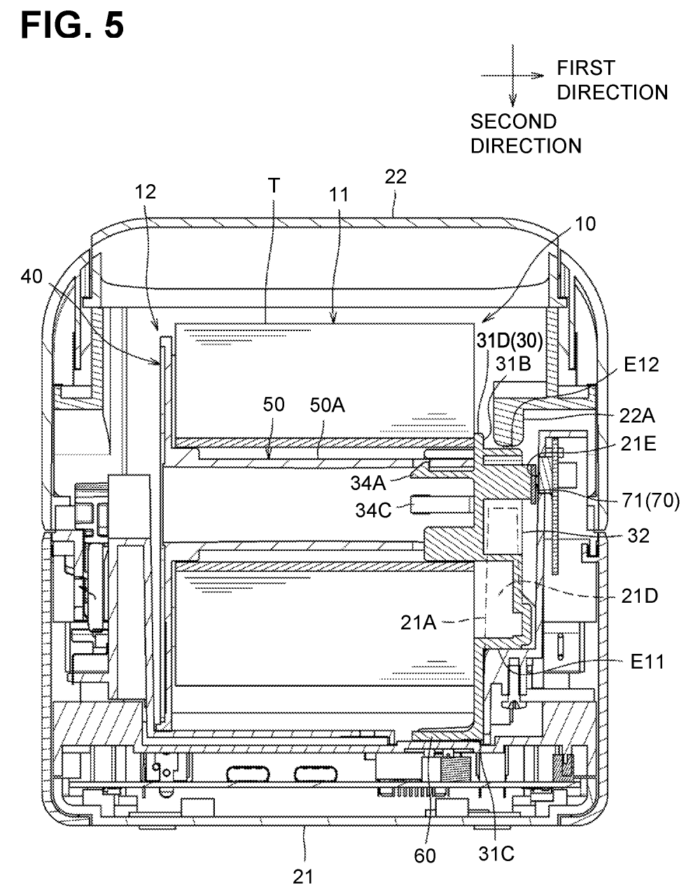

As shown in FIG. 5, when the tape cassette 10 is mounted to the housing body 21, the electrical contact 21E comes into contact with the electrical contact surface 71 of the memory 70 of the holder 12. In other words, when the guide protrusion 32 of the holder 12 enters the guide groove 21D, the electrical contact surface 71 comes into contact with the electrical contact 21E.

By the electrical contact surface 71 coming into contact with the electrical contact 21E, a control unit (not shown) of the image forming apparatus 1 can read information from the memory 70. For example, the memory 70 stores at least one of the remaining amount of the tape roll 11, the number of times the holder 12 has been reused, and the type of tape roll 11.

Here, the type of tape roll 11 stored in the memory 70 may be the same as or different from the type set in the identification section 61. If the type of tape roll 11 stored in the memory 70 is the same as the type set in the identification section 61, even if either the memory 70 or the identification section 61 is damaged, the control unit can identify the type of tape roll 11 by using the other.

The guide protrusion 32, which protrudes from the second surface 31B of the first side plate 30, protrudes in the direction away from the second surface 31B from the first housing wall 21A when the tape cassette 10 is mounted to the housing body 21. Accordingly, when the tape cassette 10 is mounted to the housing body 21, the electrical contact surface 71 is located at a position in the first direction away from the second surface 31B from the first housing wall 21A.

The electrical contact surface 71 is located at the outer surface of the first side plate 30. The electrical contact surface 71 is located at the outer surface of the guide protrusion 32 of the first side plate 30. The electrical contact surface 71 faces in the direction opposite to the direction in which the first side plate 30 faces the second side plate 40. When the tape roll 11 is mounted to the shaft 50, the electrical contact surface 71 faces away from the tape roll 11 in the first direction. The electrical contact surface 71 faces, in the first direction, the direction in which the guide protrusion 32 protrudes from the second surface 31B of the first side plate 30. The electrical contact surface 71 is located, in the first direction, at the opposite side of the first side plate 30 from the second side plate 40. In other words, in the first direction, the first side plate 30 is located between the electrical contact surface 71 and the second side plate 40. The electrical contact surface 71 is located, in the first direction, at the opposite side of the plate-shaped portion 31 of the first side plate 30 from the guide protrusion 32. In other words, in the first direction, the guide protrusion 32 is located between the electrical contact surface 71 and the plate-shaped portion 31 of the first side plate 30. When the tape roll 11 is mounted to the shaft 50, the electrical contact surface 71 is located, in the first direction, at the opposite side of the first side plate 30 from the tape roll 11. In other words, in the first direction, the first side plate 30 is located between the electrical contact surface 71 and the tape roll 11.

The electrical contact surface 71 is aligned with the shaft 50 in the first direction. Note that only a part of the electrical contact surface 71 may be aligned with the shaft 50 in the first direction. The guide protrusion 32 extends in the second direction. The guide protrusion 32 includes one end E11 and another end E12 in the second direction. The another end E12 is located at a position separated from the one end E11 in the second direction. The electrical contact surface 71 is located closer to the another end E12 of the guide protrusion 32 than to the one end E11 in the second direction. The distance between the electrical contact surface 71 and the one end E11 of the guide protrusion 32 in the second direction is longer than the distance

between the electrical contact surface 71 and the another end E12 of the guide protrusion 32 in the second direction.

The electrical contact surface 71 is located closer to another end portion 31D of the first side plate 30 than to one end portion 31C of the first side plate 30 in the second direction. The distance between the electrical contact surface 71 and the another end portion 31D of the first side plate 30 in the second direction is shorter than the distance between the electrical contact surface 71 and the one end portion 31C of the first side plate 30 in the second direction.

The distance between the electrical contact surface 71 and the bottom plate 60 in the second direction is longer than the distance between the electrical contact surface 71 and the another end portion 31D of the first side plate 30 in the second direction.

Returning to FIG. 1, the four switches SW1, SW2, SW3, and SW4 are switches that can come into contact with the identification section 61 of the holder 12 shown in FIG. 4 when the tape cassette 10 is mounted to the housing body 21. The three holes 61A, 61B, and 61C of the identification section 61 do not press the switches SW1, SW2, and SW3. The portion 61D of the bottom plate 60 without the holes 61A, 61B, and 61C presses the switch SW4. The control unit of the image forming apparatus 1 determines the type of tape roll 11 by identifying the combination of the pressed switch SW4 and the unpressed switches SW1, SW2, and SW3.

The cover 22 is rotatable with respect to the housing body 21. The cover 22 is rotatable about a cover shaft X1 extending in the first direction.

The cover 22 includes a cover protrusion 22A. As shown in FIG. 5, when the tape cassette 10 is mounted to the housing body 21 and the cover 22 is closed, the cover protrusion 22A contacts the first side plate 30 from the other side in the second direction. Accordingly, even if the tape cassette is not correctly mounted to the housing body 21, the cover protrusion 22A contacts the first side plate 30, thereby allowing the tape cassette 10 to be moved to the correct position with respect to the housing body 21.

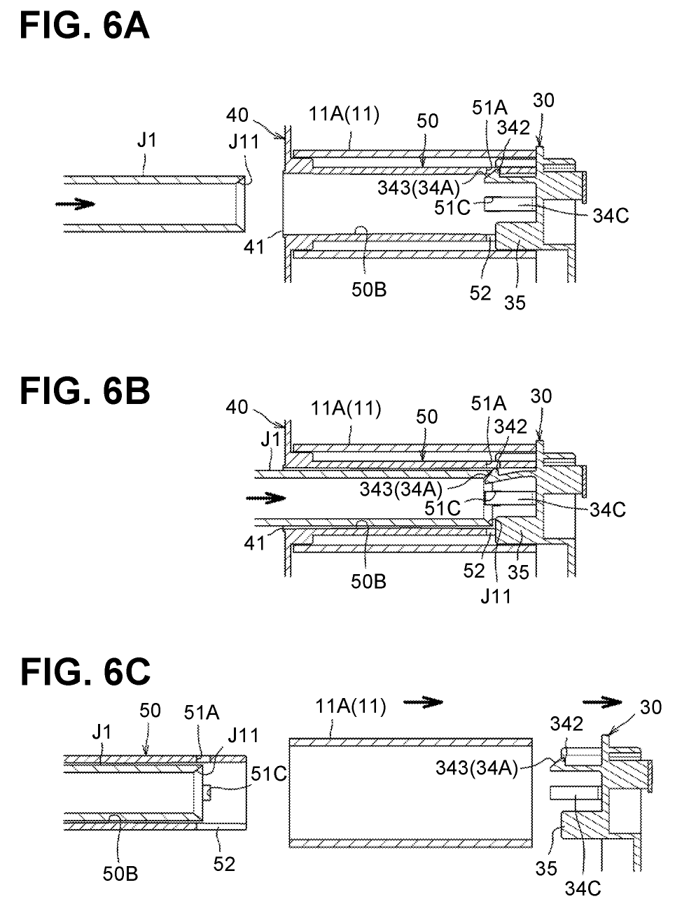

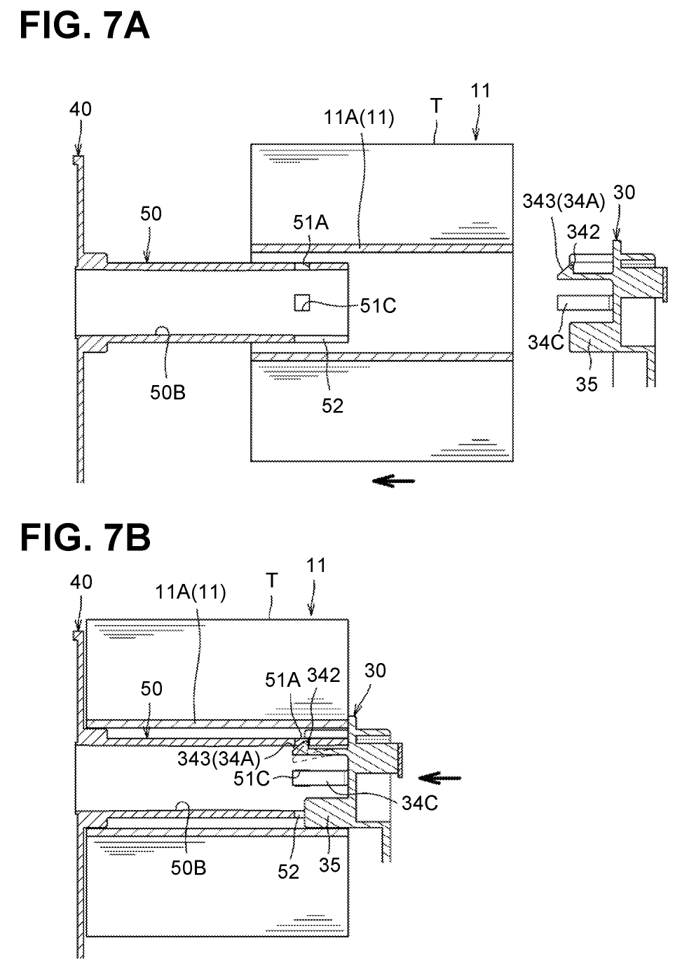

Next, a method for reusing the holder 12 will be described. The method for reusing the holder 12 has a first step shown in FIGS. 6A and 6B, a second step shown in FIG. 6C, a third step shown in FIGS. 6C and 7A, and a fourth step shown in FIG. 7B.

As shown in FIG. 6A, in the first step, an operator inserts a cylindrical jig J1 into the shaft 50 from the opening 41 of the second side plate 40. Here, the outer diameter of the jig J1 is smaller than the inner peripheral surface 50B of the shaft 50.

Further, the tip of the jig J1 includes an inclined surface J11 that is inclined with respect to the first direction. Specifically, the inclined surface J11 is inclined so as to widen as it approaches the tip of the jig J1.

In the first step, the operator moves the jig J1 along the inner peripheral surface 50B of the shaft 50 to disengage the claw 342 of the hook 34A from the hole 51A, to disengage the claw (not shown) of the hook 34B from the hole 51B, and to disengage the claw (not shown) of the hook 34C from the hole 51C. Hereinafter, with reference to FIG. 6B, the process in which the claw 342 of the hook 34A is disengaged from the hole 51A will be described.

The operator moves the jig J1 along the inner peripheral surface 50B of the shaft 50 and brings the inclined surface J11 of the jig J1 into contact with the inclined surface 343 of the hook 34A. Specifically, the operator presses the inclined surface J11 of the jig J1 against the inclined surface 343 of the hook 34A. The inclined surface J11 moves the hook 34A from the first position to the second position. As a result, the claw 342 of the hook 34A is disengaged from the hole 51A.

After the first step, the operator performs the second step. As shown in FIG. 6C, in the second step, the operator detaches the first side plate 30 from the shaft 50. After detaching the first side plate 30 from the shaft 50, the operator detaches the jig J1 from the shaft 50.

After the second step, the operator performs the third step. In the third step, the operator detaches the roll 11A of the used tape roll 11 from the shaft 50. Further, in the third step, as shown in FIG. 7A, the operator mounts a new tape roll 11 on the shaft 50.

After the third step, the operator performs the fourth step. In the fourth step, as shown in FIG. 7B, the operator attaches the first side plate 30 to the shaft 50. Specifically, the operator aligns the protrusion 35 of the first side plate 30 with the slit 52 of the shaft 50, and moves the first side plate 30 toward the second side plate 40. When the inclined surface 343 of the hook 34A contacts the end of the shaft 50, the hook 34A moves from the first position to the second position, and the claw 342 comes into contact with the inner peripheral surface 50B. When the operator further moves the first side plate 30 toward the second side plate 40 so that the claw 342 reaches the hole 51A, the hook 34A moves from the second position to the first position, and the claw 342 enters the hole 51A. As a result, the attachment of the first side plate 30 to the shaft 50 is completed.

As described above, according to the present embodiment, the following effects can be obtained. By configuring the first side plate 30 to be attachable to and detachable from the shaft 50, the holder 12 can be reused.

By configuring the three hooks 34A, 34B, and 34C located at the first position to face the inner peripheral surface 50B of the shaft 50, it becomes easy to bring the jig J1 inserted into the shaft 50 into contact with the three hooks 34A, 34B, and 34C during reuse.

By configuring the second side plate 40 to have an opening 41 that exposes the inner peripheral surface 50B of the shaft 50, it becomes easy to insert the jig J1 into the shaft 50 during reuse.

By configuring the holder 12 to include a memory 70, a large amount of information can be read from the memory 70 of the holder 12.

### Second Embodiment

Next, the second embodiment of the present disclosure will be described in detail with reference to the drawings as appropriate. Since the present embodiment is a modification of part of the structure of the tape cassette 10 according to the first embodiment described above, the same reference numerals are used for substantially the same components as in the first embodiment, and their description will be omitted.

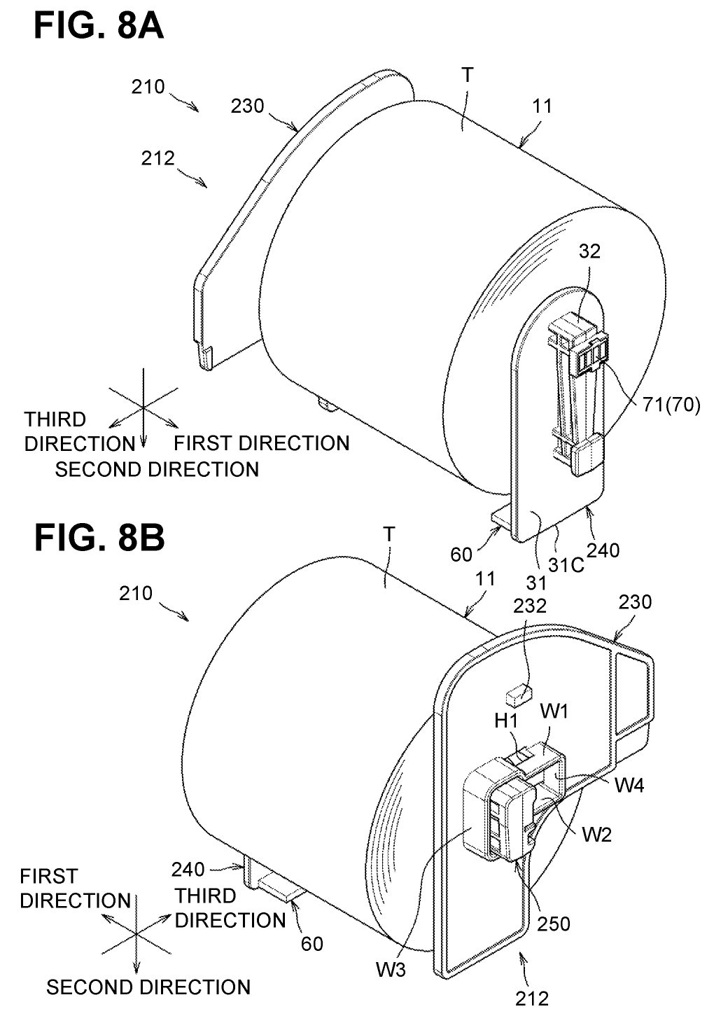

As shown in FIGS. 8A and 8B, the tape cassette 210 according to the second embodiment includes a tape roll 11 substantially the same as in the first embodiment and a holder 212. The holder 212 is made of, for example, resin. The holder 212 includes a first side plate 240, a second side plate 230, a shaft 250, a bottom plate 60, and a memory 70.

With the tape roll 11 mounted at the shaft 250, the tape roll 11 is located between the first side plate 240 and the second side plate 230.

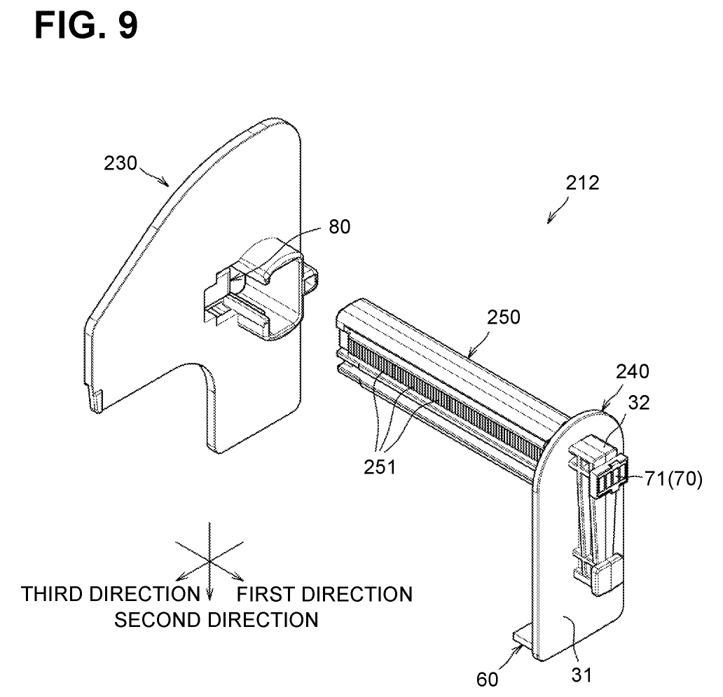

As shown in FIG. 9, the second side plate 230 is attachable to and detachable from the shaft 250. The first side plate 240 and the shaft 250 are integrally molded. Note that the first side plate 240 and the shaft 250 may be molded separately.

The first side plate 240 faces the second side plate 230 in the first direction. The first side plate 240 is located at a position separated from the second side plate 230 in the first direction.

The first side plate 240 includes a plate portion 31 and a guide protrusion 32 substantially the same as those in the first embodiment. The electrical contact surface 71 is located at the outer surface of the guide protrusion 32. The bottom plate 60 extends in the first direction from one end portion 31C of the plate portion 31 toward the second side plate 230.

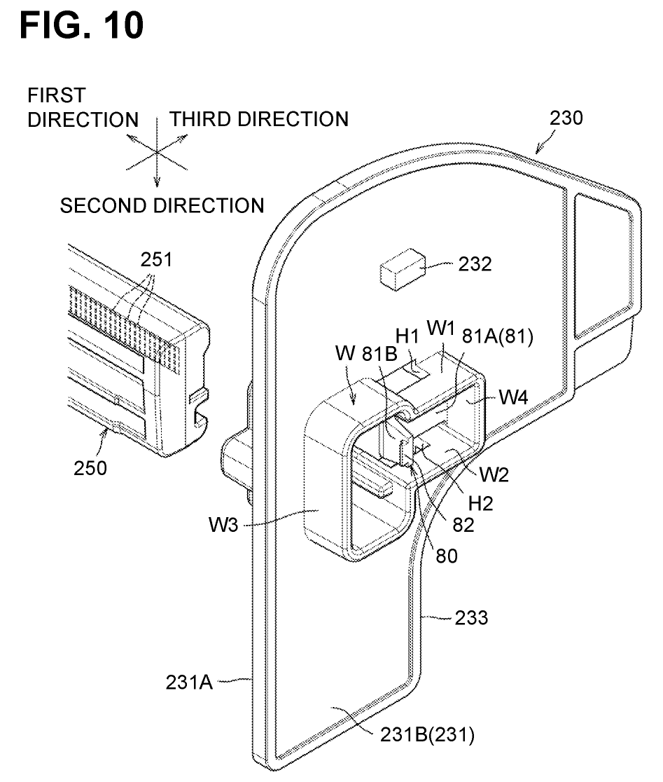

As shown in FIG. 10, the shaft 250 has a plurality of grooves 251. The plurality of grooves 251 are arranged in the first direction.

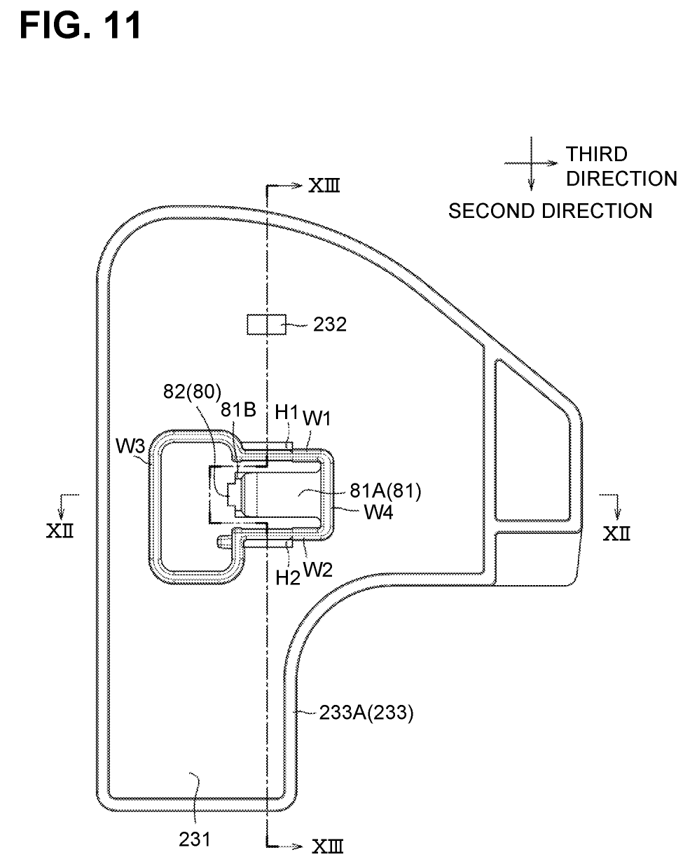

As shown in FIGS. 10 and 11, the second side plate 230 includes a plate portion 231, a wall W, a hook 80, a first protrusion 232, and a second protrusion 233. The plate portion 231 includes a first surface 231A and a second surface 231B. The first surface 231A and the second surface 231B are orthogonal to the first direction. The first surface 231A faces the first side plate 240. The second surface 231B faces in the direction opposite to the first surface 231A.

The wall W, the first protrusion 232, and the second protrusion 233 protrude from the second surface 231B of the plate portion 231. The wall W has a cylindrical shape. The shaft 250 can pass through the wall W. The wall W includes a first wall W1, a second wall W2, a third wall W3, and a fourth wall W4.

The first wall W1 faces the second wall W2 in the second direction. The hook 80 is located between the first wall W1 and the second wall W2. The first wall W1 has a first exposure hole H1. The second wall W2 has a second exposure hole H2. The first exposure hole H1 and the second exposure hole H2 expose a part of the hook 80.

The third wall W3 has a C-shape. The third wall W3 connects the first wall W1 and the second wall W2. As shown in FIG. 8B, the third wall W3 surrounds the shaft 250 when the second side plate 230 is attached to the shaft 250.

The fourth wall W4 is located opposite to the third wall W3 with respect to the first wall W1. The fourth wall W4 connects the first wall W1 and the second wall W2.

As shown in FIG. 10, the hook 80 includes an arm 81 and a claw 82. The arm 81 includes a first portion 81A and a second portion 81B.

The first portion 81A extends in the third direction from the fourth wall W4 toward the shaft 250 when the second side plate 230 is attached at the shaft 250. The second portion 81B is located at the tip of the first portion 81A. The second portion 81B extends from the first portion 81A in the first direction. Specifically, the second portion 81B extends in a direction from the first side plate 240 toward the second side plate 230.

The claw 82 can enter the groove 251 of the shaft 250. The claw 82 is located at the tip of the second portion 81B. The claw 82 protrudes from the second portion 81B toward the shaft 250 when the second side plate 230 is attached at the shaft 250.

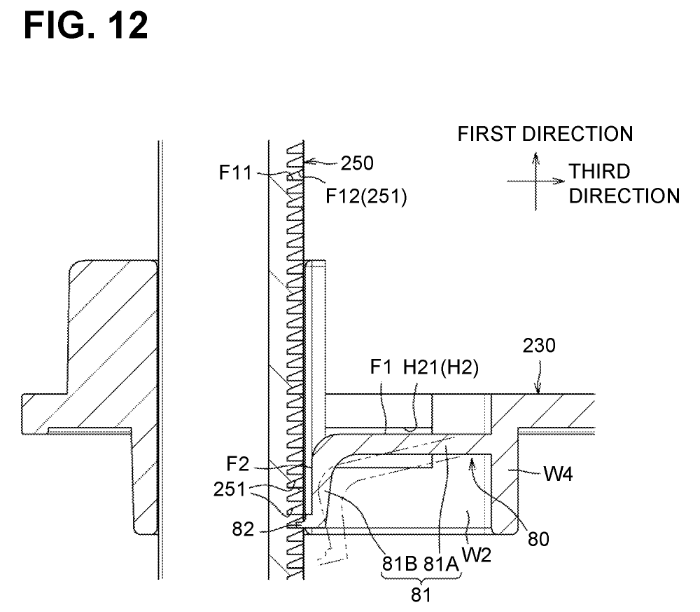

As shown in FIG. 12, in the state where the second side plate 230 is attached to the shaft 250, the hook 80 is movable between a first position indicated by a solid line and a second position indicated by a two-dot chain line. In other words, the claw 82 of the hook 80 is movable between the first position and the second position. When the hook 80 is located at the first position, the claw 82 of the hook 80 fits into the groove 251. When the hook 80 is located at the second position, the claw 82 of the hook 80 is separated from the groove 251.

The first portion 81A includes a first surface F1. The second portion 81B includes a second surface F2. When the hook 80 is located at the first position, the first surface F1 faces the first side plate 240 in the first direction. When the hook 80 is located at the first position and the second side plate 230 is attached to the shaft 250, the second surface F2 faces the plurality of grooves 251 in the third direction.

The first surface F1 extends in the second direction and the third direction. The second surface F2 extends in the first direction and the second direction.

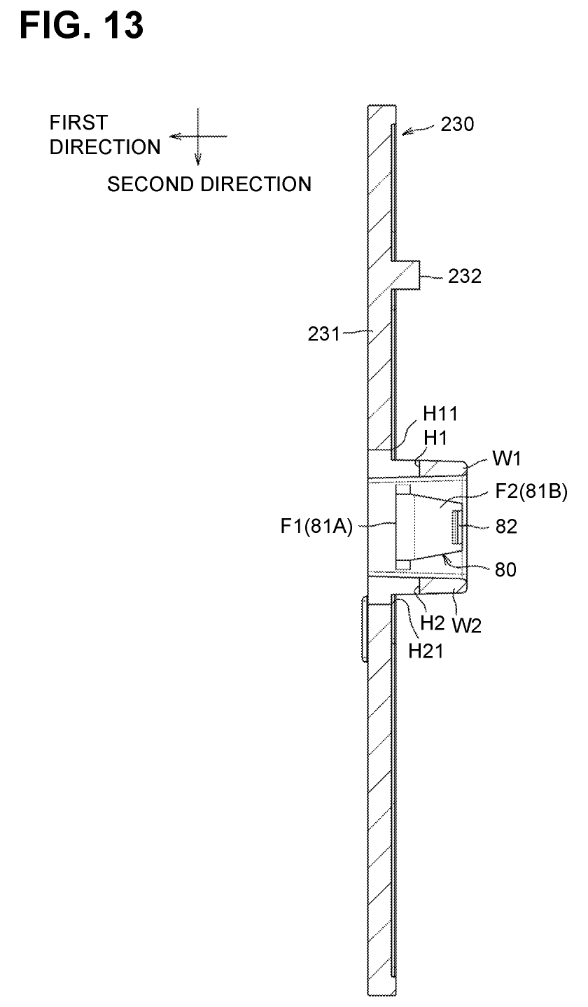

The second exposure hole H2 has the same shape as the first exposure hole H1. The position of the second exposure hole H2 in the first direction and the third direction is the same as the position of the first exposure hole H1 in the first direction and the third direction. As shown in FIG. 13, the first surface F1 overlaps with the first exposure hole H1 in the second direction.

The first exposure hole H1 extends from the first wall W1 to the plate portion 231. The second exposure hole H2 extends from the second wall W2 to the plate portion 231.

As shown in FIGS. 12 and 13, in the second direction, the first surface F1 is located at a distance from a part H21 of the edge of the second exposure hole H2. Also, in the first direction, the first surface F1 is located at a distance from a part H21 of the edge of the second exposure hole H2. As shown in FIG. 13, in the second direction, the first surface F1 is located at a distance from a part H11 of the edge of the first exposure hole H1. Also, in the first direction, the first surface F1 is located at a distance from a part H11 of the edge of the first exposure hole H1.

Accordingly, it is possible to insert the tip of the jig J2, described later, between the part H21 of the edge of the second exposure hole H2 and the first surface F1, and bring the jig J2 into contact with the first surface F1. Similarly, it is possible to insert the tip of the jig J2, described later, between the part H11 of the edge of the first exposure hole H1 and the first surface F1, and bring the jig J2 into contact with the first surface F1.

The groove 251 includes a first surface F11 and a second surface F12. When the hook 80 is located at the first position, the first surface F11 contacts the claw 82 of the hook 80. The first surface F11 is orthogonal to the first direction. The first surface F11 suppresses movement of the second side plate 230 in the direction away from the first side plate 240.

When the second side plate 230 moves in a direction approaching the first side plate 240, the second surface F12 contacts the claw 82 of the hook 80 and moves the claw 82 from the first position toward the second position. The second surface F12 is inclined with respect to the first direction. Specifically, the second surface F12 is inclined so as to approach the hook 80 as it gets closer in the direction from the second side plate 230 toward the first side plate 240.

As shown in FIGS. 10 and 11, the first protrusion 232 is located at the side of the first wall W1 opposite to the hook 80. In other words, the first wall W1 is located between the first protrusion 232 and the hook 80. The first protrusion 232 overlaps with the first exposure hole H1 when viewed in the second direction.

The second protrusion 233 is an annular protrusion that surrounds the wall W. The second protrusion 233 includes a portion 233A that overlaps with the second exposure hole H2 in the second direction. The portion 233A is located at the side of the second wall W2 opposite to the hook 80. In other words, the second wall W2 is located between the portion 233A and the hook 80.

Next, a method for reusing the holder 212 will be described. The reuse method of the second embodiment has a first step different from that of the first embodiment, and a second step, a third step, and a fourth step which are substantially the same as those of the first embodiment.

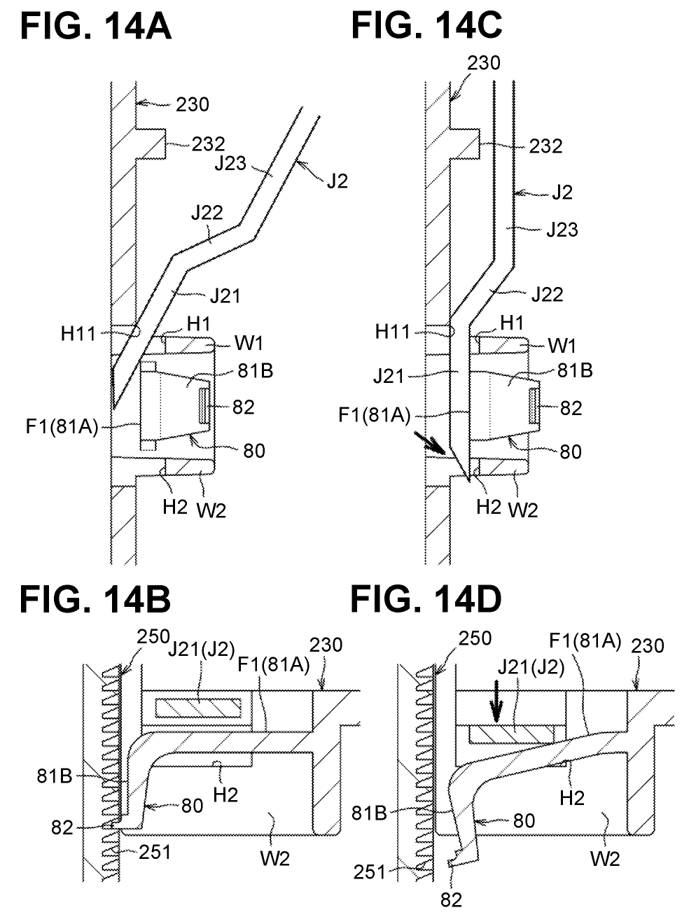

In the first step, the jig J2 shown in FIG. 14A is used. The jig J2 includes a first portion J21, a second portion J22, and a third portion J23. The jig J2 is rod-shaped.

The first portion J21 extends in a predetermined direction. One end of the first portion J21 has a tapered shape. The second portion J22 extends from another end of the first portion J21 in a direction different from the predetermined direction. The second portion J22 is located between the first portion J21 and the third portion J23.

The third portion J23 extends in a predetermined direction from the second portion J22. The third portion J23 extends in a direction away from the first portion J21.

As shown in FIGS. 14A and 14B, in the first step, the operator first inserts the tip of the first portion J21 of the jig J2 into the first exposure hole H1. Thereafter, the operator brings the first portion J21 to face the first surface F1 of the hook 80. Specifically, the operator inserts the first portion J21 into the first exposure hole H1 so that the tip of the first portion J21 passes between a part H11 of the edge of the first exposure hole H1 and the first surface F1.

Thereafter, as shown in FIG. 14C, the operator rotates the jig J2 using a part H11 of the edge of the first exposure hole H1 as a fulcrum. When the jig J2 is rotated, the first portion J21 comes into contact with the first surface F1 and pushes the hook 80. As a result, as shown in FIG. 14D, the hook 80 moves from the first position to the second position, and the claw 82 of the hook 80 is disengaged from the groove 251.

After the first step, the operator performs the second step. As shown in FIG. 9, in the second step, the operator moves the second side plate 230 in a direction away from the first side plate 240. Thereafter, the operator detaches the second side plate 230 from the shaft 250. Then, the operator detaches the jig J2 from the second side plate 230.

After the second step, the operator performs the third step. Although not illustrated, in the third step, the operator detaches the used tape roll 11 from the shaft 250. Then, the operator mounts a new tape roll 11 onto the shaft 250.

After the third step, the operator performs the fourth step. In the fourth step, as shown in FIG. 10, the operator inserts the shaft 250 into the wall W of the second side plate 230, thereby attaching the second side plate 230 at the shaft 250.

As described above, according to the second embodiment, the following effects can be obtained. By configuring the second surface F12 of the groove 251 to move the hook 80 from the first position to the second position when the second side plate 230 moves in a direction approaching the first side plate 240, it is possible to adjust the distance between the second side plate 230 and the first side plate 240.

Note that, in the reuse method of the holder 212 of the second embodiment, the jig J2 is used, but, for example, an L-shaped jig may also be used. That is, the jig may include a first portion extending in a predetermined direction and a second portion extending from the first portion in a direction different from the predetermined direction.

### Third Embodiment

Next, the third embodiment of the present disclosure will be described in detail with reference to the drawings as appropriate. It should be noted that this embodiment is a modification of a part of the structure of the image forming apparatus 1 according to the first embodiment described above. Therefore, components substantially the same as those of the first embodiment are denoted by the same reference numerals, and their explanation will be omitted.

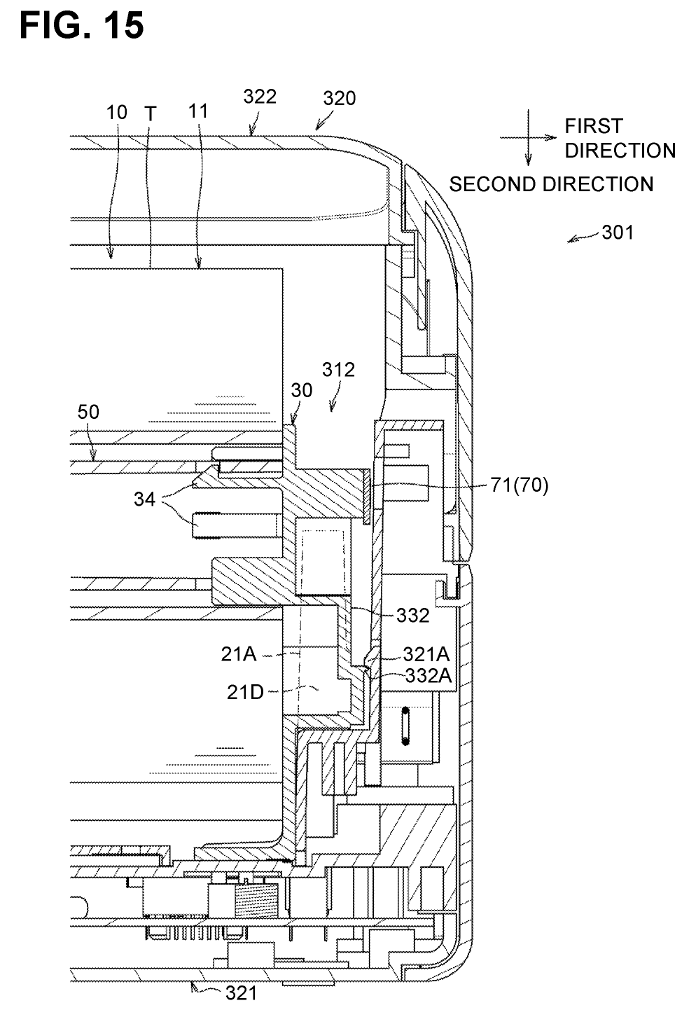

As shown in FIG. 15, the image forming apparatus 301 of the third embodiment includes a housing 320 and a guide projection 332, which have a somewhat different structure from those of the first embodiment.

The housing 320 includes a housing main body 321 and a cover 322. The cover 322 of the third embodiment differs from the cover 22 of the first embodiment in that it does not include the cover projection 22A.

The housing main body 321 of the third embodiment includes a hook 321A that is not present in the first embodiment. The other structure of the housing main body 321 is substantially the same as that of the housing main body 21 of the first embodiment.

The guide projection 332 of the third embodiment includes a projection 332A that is not present in the first embodiment. The other structure of the holder 312 of the third embodiment is substantially the same as that of the holder 12 of the first embodiment.

The hook 321A comes into contact with the first side plate 30 when the tape cassette 10 is mounted at the housing main body 321. Specifically, when the tape cassette 10 is mounted at the housing main body 321, the hook 321A comes into contact with the projection 332A of the guide projection 332.

The hook 321A contacts the projection 332A from the other side in the second direction. As a result, even if the tape cassette 10 is not correctly mounted at the housing main body 321, the hook 321A comes into contact with the projection 332A of the guide projection 332, thereby allowing the tape cassette 10 to be moved to the correct position with respect to the housing main body 321.

### Fourth Embodiment

Next, the fourth embodiment of the present disclosure will be described in detail with reference to the drawings as appropriate. It should be noted that this embodiment is a modification of a part of the structure of the holder 12 according to the first embodiment described above. Therefore, components substantially the same as those of the first embodiment are denoted by the same reference numerals, and their explanation will be omitted.

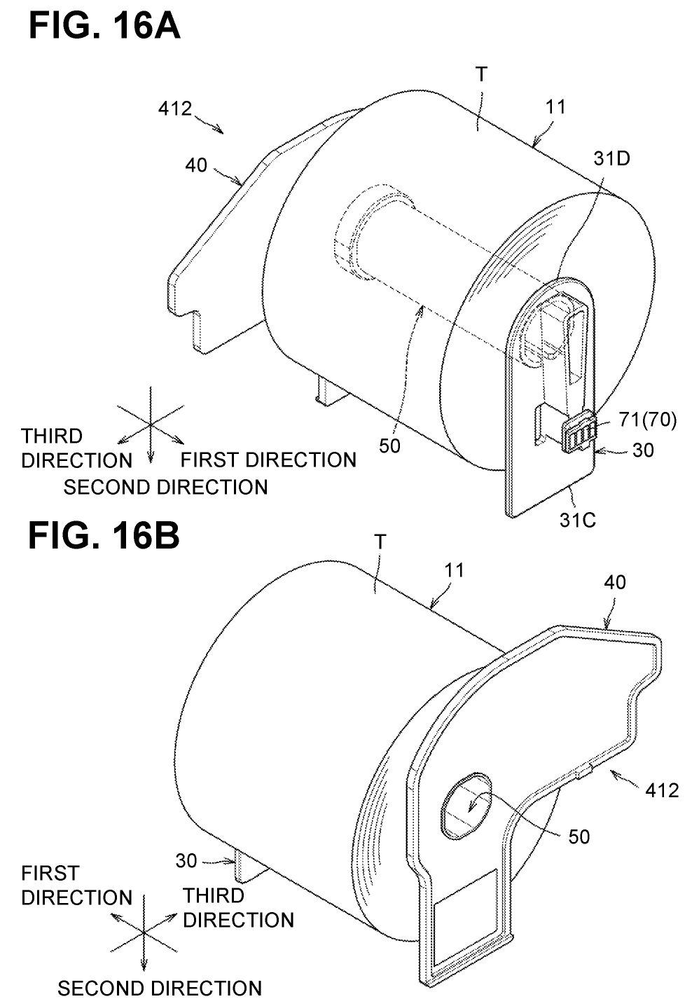

As shown in FIGS. 16A and 16B, the holder 412 according to the fourth embodiment differs from the first embodiment in that it does not include a bottom plate 60. In the fourth embodiment, the holder 412 does not include an identification section 61. The holder 412 includes a memory 70.

Further, in the fourth embodiment, as shown in FIG. 16A, the electrical contact surface 71 is located at a position between the shaft 50 and one end 31C of the first side plate 30 in the second direction. Note that, in the first embodiment, the position of the memory 70 may also be set to the position shown in FIG. 16A. In this case, the electrical contact surface 71 is located at a position between the shaft 50 and the bottom plate 60 in the second direction.

### Fifth Embodiment

Next, the fifth embodiment of the present disclosure will be described in detail with reference to the drawings as appropriate. It should be noted that this embodiment is a modification of part of the structure of the holder 212 according to the second embodiment described above. Therefore, components substantially the same as those of the second embodiment are denoted by the same reference numerals, and their explanation will be omitted.

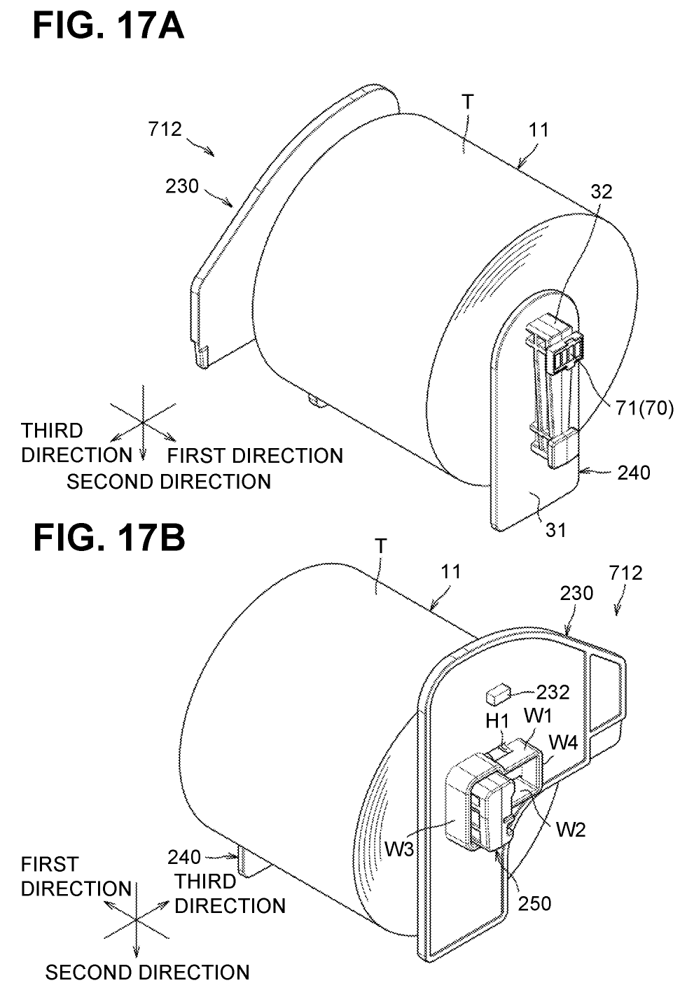

As shown in FIGS. 17A and 17B, the holder 712 according to the fifth embodiment differs from the second embodiment in that it does not include a bottom plate 60. In the fifth embodiment, the holder 712 does not include an identification section 61. The holder 712 includes a memory 70.

It should be noted that the present disclosure is not limited to the above embodiments and can be implemented in various forms as exemplified below.

The shaft hole is not limited to a through hole. For example, the shaft hole may be a blind hole.

The first exposure hole only needs to expose at least a part of the hook. That is, the first exposure hole may expose the entire hook. The second exposure hole only needs to expose at least a part of the hook. That is, the second exposure hole may expose the entire hook.

The first exposure hole may expose the second surface F2 of the second portion 81B of the hook 80 in the second embodiment. The second exposure hole may expose the second surface F2 of the second portion 81B of the hook 80 in the second embodiment.

The first side plate or the second side plate may be fixed to the shaft by welding or the like.

The identification section may have a configuration including a first colored portion and a second colored portion different from the first color. In this case, the control unit of the image forming apparatus may detect the intensity of light reflected by the identification section using a reflection-type optical sensor, and identify the type of tape roll based on the distribution of light intensity.

The second direction only needs to be a direction intersecting the first direction. The third direction only needs to be a direction intersecting both the first direction and the second direction.

The respective elements described in the above embodiments and modifications may be combined arbitrarily for implementation.

What is claimed is:

1. A holder comprising:
a shaft extending in a first direction, the shaft being configured to allow a tape roll to be mounted;
a first side plate located at one end of the shaft in the first direction;
a second side plate located at another end of the shaft in the first direction, the second side plate being spaced apart from the first side plate in the first direction; and
a memory including an electrical contact surface,
wherein the first side plate includes:
a first surface facing the second side plate in the first direction; and
a second surface located at the opposite side of the first surface in the first direction, and
wherein the electrical contact surface is located at the second surface and faces in a direction from the second side plate toward the first side plate.

2. The holder according to claim 1,
wherein the first side plate extends in a second direction crossing the first direction, and includes one end and another end in the second direction, and
wherein the electrical contact surface is located closer to the another end of the first side plate than to the one end of the first side plate in the second direction.

3. The holder according to claim 1,
wherein the first side plate extends in a second direction crossing the first direction, and includes one end and another end in the second direction, and
wherein a distance between the electrical contact surface and the another end of the first side plate in the second direction is shorter than a distance between the electrical contact surface and the one end of the first side plate in the second direction.

4. The holder according to claim 1,
wherein the first side plate extends in a second direction crossing the first direction, and includes one end and another end in the second direction,
wherein the second side plate extends in the second direction, and includes one end and another end in the second direction,
wherein the one end of the shaft in the first direction is located at the another end of the first side plate in the second direction, and
wherein the another end of the shaft in the first direction is located at the another end of the second side plate in the second direction.

5. The holder according to claim 1,
wherein the memory stores at least one of a remaining amount of the tape roll, a number of times the holder has been reused, and a type of the tape roll.

6. The holder according to claim 1,
wherein the shaft extends from the second side plate to the first side plate in the first direction.

7. The holder according to claim 1,
wherein, in a state where the tape roll is mounted to the shaft, the tape roll is located between the first side plate and the second side plate.

8. The holder according to claim 1,
wherein the shaft connects the first side plate and the second side plate.

9. The holder according to claim 1,
wherein, in a state where the tape roll is mounted to the shaft, the electrical contact surface faces away from the tape roll in the first direction.

10. The holder according to claim 1,
wherein the first side plate includes a guide protrusion protruding in the first direction, and
wherein the electrical contact surface is located at an outer surface of the guide protrusion.

11. The holder according to claim 10,
wherein the guide protrusion extends in a second direction crossing the first direction, the guide protrusion includes one end and another end in the second direction, and
wherein the electrical contact surface is located closer to the another end of the guide protrusion than to the one end of the guide protrusion in the second direction.

12. The holder according to claim 10,
wherein the guide protrusion extends in a second direction crossing the first direction, the guide protrusion includes one end and another end in the second direction, and
wherein a distance between the electrical contact surface and the another end of the guide protrusion in the second direction is shorter than a distance between the electrical contact surface and the one end of the guide protrusion in the second direction.

13. The holder according to claim 1, further comprising a bottom plate extending in the first direction from one end of the first side plate in a second direction crossing the first direction,
wherein the electrical contact surface is located between the shaft and the bottom plate in the second direction.

14. The holder according to claim 1,
wherein at least a part of the electrical contact surface is aligned with the shaft in the first direction.

15. The holder according to claim 14,
wherein all of the electrical contact surface is aligned with the shaft in the first direction.

16. The holder according to claim 1,
wherein the first side plate includes one end and another end spaced apart from the one end in a second direction,
wherein the holder further comprises a bottom plate extending in the first direction from the one end of the first side plate, and
wherein a distance between the electrical contact surface and the bottom plate in the second direction is longer than a distance between the electrical contact surface and the another end of the first side plate in the second direction.

17. The holder according to claim 1, further comprising:
a bottom plate extending in the first direction from one end of the first side plate in a second direction, and
an identification portion located at the bottom plate.

18. The holder according to claim 17,
wherein the identification portion has a shape capable of identifying a type of the tape roll.

19. A tape cassette comprising:
a holder including:
a shaft extending in a first direction;
a first side plate located at one end of the shaft in the first direction;
a second side plate located at another end of the shaft in the first direction, the second side plate being spaced apart from the first side plate in the first direction; and
a memory including an electrical contact surface, and
a tape roll rotatable about the shaft,
wherein the first side plate includes:
a first surface facing the second side plate in the first direction; and
a second surface located at the opposite side of the first surface in the first direction, and
wherein the electrical contact surface is located at the second surface and faces in a direction from the second side plate toward the first side plate.

20. An image forming apparatus comprising:
a tape cassette; and
a housing to which the tape cassette is detachably mountable,
wherein the tape cassette including:
a holder including:
a shaft extending in a first direction;
a first side plate located at one end of the shaft in the first direction;
a second side plate located at another end of the shaft in the first direction, the second side plate being spaced apart from the first side plate in the first direction; and
a memory including an electrical contact surface, and
a tape roll rotatable about the shaft,
wherein the first side plate includes:
a first surface facing the second side plate in the first direction; and
a second surface located at the opposite side of the first surface in the first direction,
wherein the electrical contact surface is located at the second surface and faces in a direction from the second side plate toward the first side plate, and
wherein the housing includes an electrical contact configured to contact the electrical contact surface.

21. The image forming apparatus according to claim 20,
wherein the first side plate includes a guide protrusion protruding in the first direction,
wherein the housing has a guide groove into which the guide protrusion is inserted, and
wherein, in a state where the guide protrusion is inserted into the guide groove, the electrical contact surface contacts the electrical contact.

22. The image forming apparatus according to claim 20,
wherein the housing includes:
a cover rotatable about a cover shaft extending in the first direction; and
a hook configured to contact the first side plate when the tape cassette is mounted to the housing.

23. The image forming apparatus according to claim 20,
wherein the holder includes:
a bottom plate extending in the first direction from one end of the first side plate in a second direction; and
an identification portion located at the bottom plate, and
wherein the housing includes a switch configured to contact the identification portion when the tape cassette is mounted to the housing.
